(19) United States
(12) Patent Application Publication
(10) Pub. No.: US 2021/0216934 A1
(43) Pub. Date: Jul. 15, 2021

(54) MANAGING FLEXIBLE GRID RESOURCES

(71) Applicant: Carrier Corporation, Palm Beach Gardens, FL (US)

(72) Inventors: Stefano Riverso, Cork (IE); Marcello Torchio, Cork (IE); Piotr Sobonski, Cork (IE); Sarah O'Connell, Cork (IE)

(21) Appl. No.: 15/733,982

(22) PCT Filed: Aug. 13, 2019
(86) PCT No.: PCT/US2019/046257

§ 371 Date: Dec. 1, 2020

Related U.S. Application Data
(60) Provisional application No. 62/718,048, filed on Aug. 13, 2018.

(51) Int. Cl. G06Q 10/06; G05B 15/02; G06Q 50/16; G06Q 50/06; H02J 3/38; H02J 3/28

(52) U.S. Cl. CPC G06Q 10/06315; G05B 15/02; G06Q 50/163; H02J 2300/20; G06Q 10/06393; H02J 3/381; H02J 3/28; G06Q 50/06

(57) ABSTRACT

Methods and systems for flexible resource management are provided. Aspects include receiving a request to adjust power consumption for a site. Obtaining a flexible resource profile for the building, analyzing the flexible resource profile to identify a flexible resource available to satisfy the request and operating the flexible resource to satisfy the request.

### BACKGROUND

Exemplary embodiments pertain to the art of demand response and more specifically to managing flexible grid resources for demand response.

Aggregators provide energy and power balancing services by acting as an intermediary between a contracting authority, typically a grid utility and buildings or sites connected to the electricity grid. The aggregator puts together a portfolio of sites to meet the minimum power or energy participation criteria set by the contracting authority to provide flexibility services such as Demand Response (DR) to the grid. Power and energy flexibility of grid connected loads, generation and storage has become increasing important for grid utilities with increasing renewable power generation on the grid. Flexibility is defined as modifying (increasing or decreasing) the electrical load profile through load shedding, ramping up, on site generation and storage, implemented using manual or automatic control of systems, while minimizing the impact on occupants and operations. At the grid level, balancing non-dispatchable generation resources such as wind or solar requires flexibility on the demand side in order to match power generation to load. The role of the aggregator is to offer the increased or decreased load, quantified in terms of electrical power (in kW or MW) and duration (time) to the grid utility in return for a financial payment, so the grid utility can balance the grid, increase renewable hosting capacity and provide grid stability for the users of the electrical network.

### BRIEF DESCRIPTION

Disclosed is a system. The system includes a processor communicatively coupled to a memory, the processor configured to receive a request to adjust power consumption for a building, obtain a flexible resource profile for the building, analyze the flexible resource profile to identify a flexible resource available to satisfy the request and operate the flexible resource to satisfy the request.

In addition to one or more of the features described above, or as an alternative, further embodiments of the system may include that the flexible resource comprises at least one of a heating ventilation and air conditioning (HVAC) system, an elevator, a power storage system, and a renewable energy system.

In addition to one or more of the features described above, or as an alternative, further embodiments of the system may include that the processor is further configured to transmit a confirmation to a requestor associated with the request.

In addition to one or more of the features described above, or as an alternative, further embodiments of the system may include that the confirmation comprises a power consumption change indicator.

In addition to one or more of the features described above, or as an alternative, further embodiments of the system may include that the request comprises a financial incentive for adjusting power consumption for the site.

In addition to one or more of the features described above, or as an alternative, further embodiments of the system may include that the flexible resource profile includes key performance indicators (KPI) for the site, each KPI having a threshold.

In addition to one or more of the features described above, or as an alternative, further embodiments of the system may include that automatically identifying the flexible resource available to satisfy the request comprises estimating an effect of adjusting operating of the flexible resource and comparing the effect to the threshold of the key performance indicators.

In addition to one or more of the features described above, or as an alternative, further embodiments of the system may include that the processor is further configured to cancel operation of the flexible resource based on a determination that the KPI threshold is exceed.

In addition to one or more of the features described above, or as an alternative, further embodiments of the system may include that the processor is further configured to transmit an indication to a requestor, the indication including a decline of the request.

In addition to one or more of the features described above, or as an alternative, further embodiments of the system may include that the flexible resource profile comprises a service level contract for the site.

Disclosed is a method. The method includes receiving a request to adjust power consumption for a site to which the aggregator responds automatically, on-line and in real time. Obtaining a flexible resource profile for the site through auto discovery to identify and quantify local flexible resources, using automated functional tests if required, on-line real time forecasting of available flexibility and solving an optimization problem to determine the total available flexibility each site can offer to the aggregator. This flexibility is then automatically controlled to satisfy the aggregator and ultimately the grid utility's request.

In addition to one or more of the features described above, or as an alternative, further embodiments of the method may include that the at least one flexible resource comprises a heating ventilation and air conditioning (HVAC) system, an elevator, a power storage system, and a renewable energy system.

In addition to one or more of the features described above, or as an alternative, further embodiments of the method may include transmitting a confirmation to a requestor associated with the request.

In addition to one or more of the features described above, or as an alternative, further embodiments of the method may include that the confirmation comprises a power consumption change indicator.

In addition to one or more of the features described above, or as an alternative, further embodiments of the method may include that the request comprises a financial incentive for adjusting power consumption for the building.

In addition to one or more of the features described above, or as an alternative, further embodiments of the method may include that the flexible resource profile includes key performance indicators for the site, each key performance indicator (KPI) having a threshold.

In addition to one or more of the features described above, or as an alternative, further embodiments of the method may include that identifying the flexible resource available to satisfy the request comprises estimating an effect of adjusting operating of the flexible resource and comparing the effect to the threshold of the key performance indicators.

In addition to one or more of the features described above, or as an alternative, further embodiments of the method may include canceling operation of the flexible resource based on a determination that the KPI threshold is exceed.

In addition to one or more of the features described above, or as an alternative, further embodiments of the method may include transmitting an indication to a requestor, the indication including a decline of the request.

In addition to one or more of the features described above, or as an alternative, further embodiments of the method may include that the flexible resource profile comprises a service level contract for the building.

### BRIEF DESCRIPTION OF THE DRAWINGS

The following descriptions should not be considered limiting in any way. With reference to the accompanying drawings, like elements are numbered alike:

FIG. 1 depicts a block diagram of a computer system for use in implementing one or more embodiments;

FIG. 2 depicts a system for flexible resource management according to one or more embodiments;

FIG. 3 depicts a flow diagram of a method for flexible resource management according to one or more embodiments; and

FIG. 4 depicts a flow diagram of a method for flexible resource management according to one or more embodiments.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

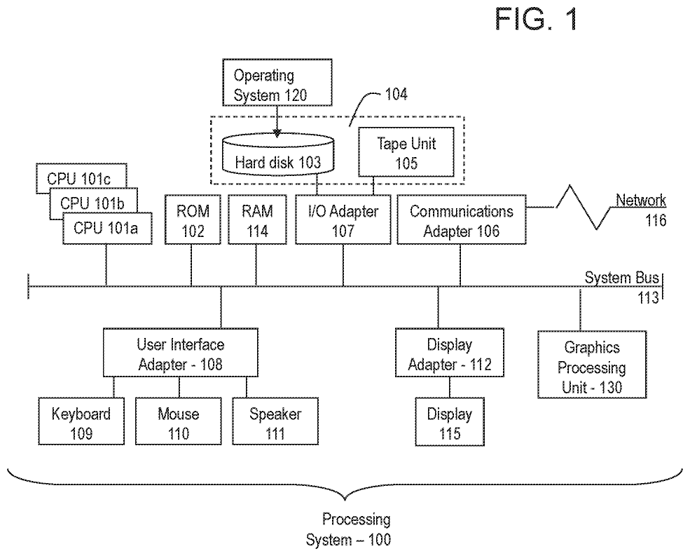

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). Processors 101 are coupled to system memory 114 and various other components via a system bus 113. Read only memory (ROM) 102 is coupled to the system bus 113 and may include a basic input/output system (BIOS), which controls certain basic functions of system 100. The processing system 100 described herein is merely exemplary and not intended to limit the application, uses, and/or technical scope of the present disclosure, which can be embodied in various forms known in the art.

FIG. 1 further depicts an input/output (I/O) adapter 107 and a network adapter 106 coupled to the system bus 113. I/O adapter 107 may communicate with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols. Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 1. FIG. 1 is merely a non-limiting example presented for illustrative and explanatory purposes.

Turning now to an overview of technologies that are more specifically relevant to aspects of the disclosure, aggregators act as an intermediary, providing energy, balancing and other Demand Response services by mediating between a contracting authority, typically a grid utility and blocks of flexible resources in the grid. Aggregators pool flexible resources e.g. buildings, which have power flexibilities below minimum participation limits and cannot deal directly with contracting authorities, to satisfy a grid request. Examples of grid requests include increasing or decreasing consumption of electrical power. This action typically translates into the application of predefined (generally contract-driven) actuations of flexible resources such as building Heating Ventilation and Air Conditioning (HVAC), storage or other building systems such as elevators. Such contractual terms are usually based on prior energy audits carried out at the building or site. Due to their fixed nature, the predefined actuations that an aggregator can carry out over a multiplicity of resources may result in under estimation of rewards (e.g., through real-time energy and power management the building could provide a higher flexibility), or negatively influence some Key Performance Indicators (KPIs) (e.g., due to contractual terms, an actuation may not compromise occupants' comfort). KPIs may be on the aggregator side or on the building/site. Examples of KPIs include % power or energy flexibility and associated time duration, CO2 or Carbon Emissions, occupant comfort, Renewable Energy Utilization factor etc.

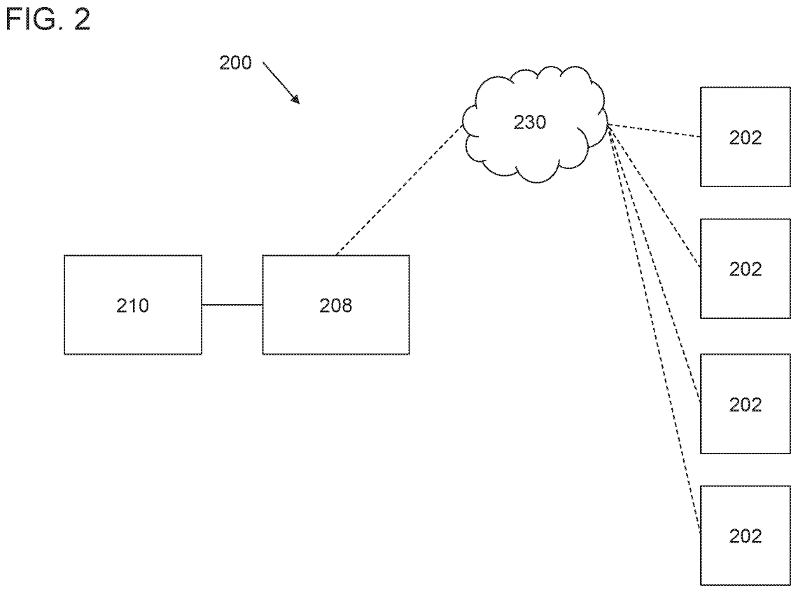

Turning now to a more detailed description of aspects of the present disclosure, FIG. 2 depicts a system for flexible resource management according to embodiments. The system 200 includes one or more energy management systems 202, an aggregator 208, and a grid utility 210. The energy management system 202 includes a transceiver that is configured to send and receive information to and from the aggregator, the grid utility, and/or a cloud server. The energy management system 202 is configured to manage one or more flexible resources within the building. In the example case of buildings, flexible resources include, but are not limited to, HVAC systems, power storage system, renewable energy generation systems, lighting systems, elevator systems, large machine systems, and the like. As described herein, the aggregator 208 manages requests from the grid utility 210 to adjust the power consumption for sites managed by the aggregator 208. For example, an aggregator may have a block or portfolio of fifty (50) sites with each site having an energy management system 202. The aggregator 208 can send requests to the block of sites to reduce or increase their power consumption due to factors associated with the grid utility 210. These factors include grid connected renewable generation which is intermittent and non-dispatchable, peak load periods for the grid, increased external temperature causing a high demand, unexpected low demand for power, and the like. The aggregator 208 can contract with the sites in its block to provide contractual incentives for sites to be included in the block. Contractual terms such as quantity of flexibility in kW or MW and available time durations may be based on approaches including but not limited to, prior energy audits carried out on the flexible resources controlled by the energy management systems 202, auto discovery of flexible resources, functional tests or other appropriate methods. The term site can include, but is not limited to, office building, manufacturing locations, warehouse areas, or any types of areas that utilize electricity.

In one or more embodiments, the building management system 202 can be implemented on the processing system 100 found in FIG. 1. Additionally, a cloud computing system can be in wired or wireless electronic communication with one or all of the elements of the system 200. Cloud can supplement, support or replace some or all of the functionality of the elements of the system 200. Additionally, some or all of the functionality of the elements of system 200 can be implemented as a node of a cloud. The cloud computing described herein is only one example of a suitable cloud computing environment and is not intended to suggest any limitation as to the scope of use or functionality of embodiments described herein.

In one or more embodiments, the energy management systems 202 can receive power adjustment requests known as flexibility requests from the aggregators 208 or from a grid utility 210 directly or through a network 230. The flexibility requests can include a request to adjust operation of a specific resource or to take a specific flexible resource offline/online to satisfy the power adjustment request. Or the flexibility request can include power adjustment level such as a percentage to reduce/increase power consumption for the site. In the example case of a building, due to high power demand, a building energy management system 202 can receive a flexibility request asking for a reduction in power consumption by 20%. The building energy management system 202 analyzes the request and the current status of each of its flexible resources to identify how to operate the flexible resources to satisfy the request. This may include adjusting a thermostat temperature in an HVAC system, shutting down one or more elevator banks, or operating a diesel generator to provide local power to the building. The energy management system 202 can also analyze the contractual terms (e.g., system parameters) to determine what, if any, flexible resources operations can be adjusted. In one or more embodiments, the energy management system 202 can transmit a confirmation to the aggregator 208 that the building can satisfy the request.

In one or more embodiments, the energy management systems 202 can communicate through a cloud server to satisfy a power adjustment request from the aggregator 208. Each energy management system 202 can identify their ability to adjust the building power consumption to meet the aggregate power consumption adjustment requested by the aggregator 208. In the example case of a two building block, a first building energy management system might be able to reduce total power consumption by 25% while the second building energy management system may only be able to reduce power consumption by 15%. Instead of the first building energy management system reducing power by the requested 20%, the system can communicate across building energy management systems to meet the need for power consumption for the block to get to 20%.

In one or more embodiments, the aggregator 208 can automatically discover the required models and parameters of the connected resources available to satisfy the power adjustment request. The energy management systems 202 can perform an auto discovery for identifying each building's local flexible resources (e.g., storages, renewables, and HVAC equipment), together parameters and models for each local flexible resource. The energy management systems 202 can autonomously perform functional tests to automatically assess the flexibility of the building according to the available equipment. Based on these functional test outcomes, the energy management system 202 can provide on-demand fast and slow flexibility estimations. The system will automatically detect, forecast, co-ordinate and optimize the flexibility of the sites. For example, after testing the flexible resources within a particular building, the building energy management system can demonstrate fast flexibility estimation such as shutting down machinery that would satisfy the power adjustment request. A slow flexibility estimate can include the reduction in a power consuming operational parameter of a system in the building such as slowly reducing the temperature of a thermostat to reduce power consumption from an HVAC system. These measures that are estimated by the building energy management systems 202 can take in to consideration comfort level of building occupants for systems like HVAC. Also, sensors within the building can determine occupancy and/or occupancy levels for different floors and locations within the building. Adjustments such as HVAC and lighting can be made where the sensors determine there are little to no occupants in certain floors/areas for a site.

In one or more embodiments, the energy management systems 202 can transmit the fast and slow flexibility estimations to the aggregator 208 to determine what flexible resources will be adjusted based on an optimization algorithm that takes in to account the contractual terms between the aggregator 208 and each site and power grid utility 210. The optimization algorithm can also include historical data about power consumption gathered from various energy audits or collected from individual technicians testing the flexible resources. Flexibility assessments can be created by the energy management systems 202 to develop flexible resource profiles that include flexible resources that are available to take offline or increase/decrease operational parameters. These flexible resource profiles can also include the contractual terms between the site and the aggregator/grid utility.

In one or more embodiments, a site can have certain key performance indicators (KPIs) that include but are not limited to, contractual terms, occupant comfort, global vs local heating applications, power reduction and time duration of the power reduction, environmental concerns (carbon reduction), renewable generation, power quality and frequency (e.g., 60 Hz or less) and adjusted payments to the facility. These KPIs can be included in the flexible resource profile and have associated thresholds. The energy management systems 202, when performing a flexibility estimate, can analyze these KPI thresholds to ensure that the limits are not exceeded when adjusting power consumption. For example, a building occupant may have a temperature KPI threshold of 25 degrees C. (78 degrees F.) for temperature within the building during the summer. When estimating power reduction, the building management system 202 is restricted from increases thermostat temperature beyond the 25 degrees C. (78 degrees F.) when estimating a reduction in power consumption. Due to KPI threshold restrictions, a site may not be able to fulfill a power adjustment request from the aggregator.

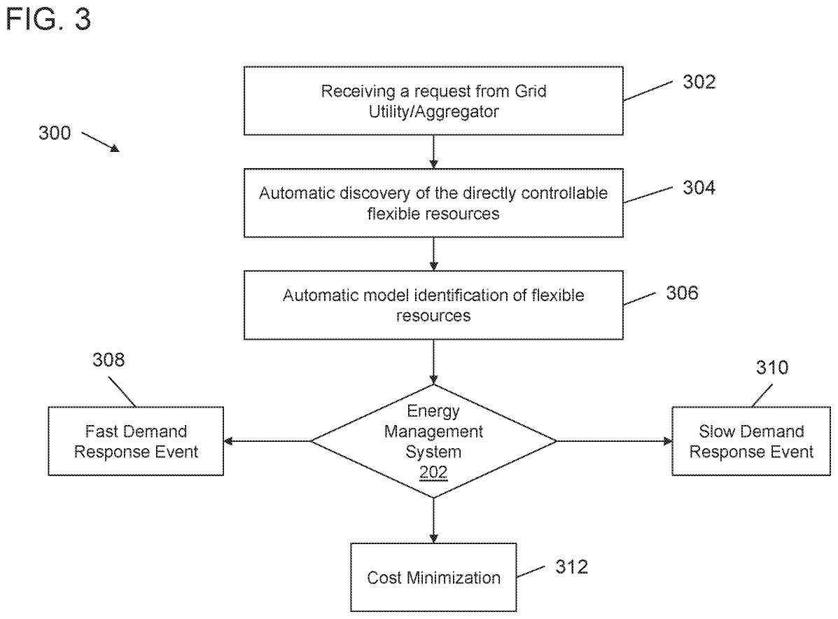

FIG. 3 depicts a flow diagram of a method for flexible resource management according to one or more embodiments. The method 300 includes process steps performed by the energy management system 202 including receiving a request from a grid utility directly or from an aggregator as shown in block 302. As described herein, the request includes a power consumption adjustment for sites connected to the grid utility. When the request is received, the method 300 then performs an automatic discovery of the directly controllable flexible resources at the site 304. Process step 306 includes performing automatic model identification of these flexible resources. The energy management system 202 can then provide on-demand fast and slow flexibility estimations. For a fast demand response event 308, the energy management system 202 can automatically check contractual agreements between an aggregator and a site, communicate flexible resource parameters than can be adjusted within any boundaries related to KPIs, and forecast flexible resource availability with mathematical models. An optimization problem can be solved to adjust the flexible resources for the demand response event and the energy management system 202 can operate the flexible resources according to the optimization solution for the demand response event. In one or more embodiments, for a slow demand response event 310, the energy management system 202 can automatically check contractual agreements between an aggregator and a site and produce forecasts for the power demand on the site along with potential renewable resources available at the site. Renewable resources include solar power, biofuel generators, and the like. An optimization problem can be solved to adjust the flexible resources for the demand response event and the energy management system 202 can operate the flexible resources according to the optimization solution for the demand response event. The energy management system 202 also performs cost minimization 312 for both a fast demand response event 308 and a slow demand response event 310. Cost minimization 312 includes identifying the costs for the site. Costs include the power costs for operating during certain times, contractual incentives for power reduction or usage of renewable energy sources, and operational costs (e.g., revenue for operating). To achieve cost minimization 312, the energy management system 202 forecasts the site power demand along with the potential for power generation on site. Utilizing mathematical models to forecast available flexibility which is input into an optimization problem, the energy management system 202 can adjust operation of flexible resources based on cost minimization considerations.

In one or more embodiments, the energy management system 202 performs auto-discovery of flexible resources. Typically, a manual energy audit by engineers is performed to determine flexible resource availability. These engineers then make an assessment of the power and analyze power consumption over a certain time based on static information. However, in one or more embodiments, the energy management system 202 for a specific site or in combination with other energy management system at other sites can recover flexible resource information automatically. A site by site analysis can be performed over certain time periods which allows for the testing of flexibility at each site.

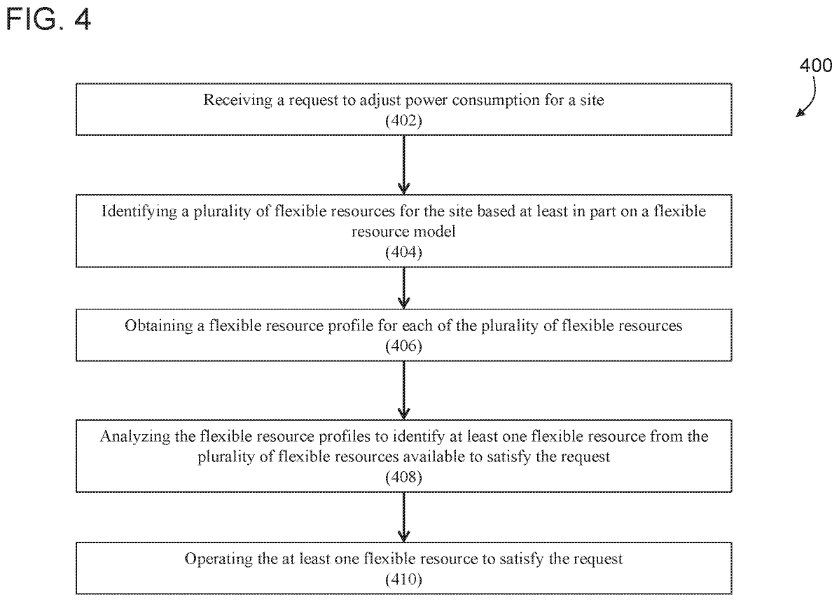

FIG. 4 depicts a flow diagram of a method for flexible resource management according to one or more embodiments. The method 400 includes receiving a request to adjust power consumption for a site, as shown in block 402. At block 404, the method 400 includes identifying a plurality of flexible resources for the site based at least in part on a flexible resource model. The method 400, at block 406, includes obtaining a flexible resource profile for each of the plurality of flexible resources. At block 408, the method 400 includes analyzing the flexible resource profiles to identify at least one flexible resource from the plurality of flexible resources available to satisfy the request. And at block 410, the method 400 includes operating the at least one flexible resource to satisfy the request.

Additional processes may also be included. It should be understood that the processes depicted in FIG. 4 represent illustrations and that other processes may be added or existing processes may be removed, modified, or rearranged without departing from the scope and spirit of the present disclosure.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a processor coupled to a memory, the processor configured to:
receive a request to adjust power consumption for a site;
obtain a flexible resource profile for the site;
analyze the flexible resource profile to identify a flexible resource available to satisfy the request; and
operate the flexible resource to satisfy the request.

2. The system of claim 1, wherein the flexible resource comprises at least one of a heating ventilation and air conditioning (HVAC) system, an elevator, a power storage system, and a renewable energy system.

3. The system of claim 1, wherein the processor is further configured to:
transmit a confirmation to a requestor associated with the request.

4. The system of claim 3, wherein the confirmation comprises a power consumption change indicator.

5. The system of claim 1, wherein the request comprises a financial incentive for adjusting power consumption for the site.

6. The system of claim 1, wherein the flexible resource profile includes key performance indicators (KPI) for the site, each KPI having a threshold.

7. The system of claim 6, wherein automatically identifying the flexible resource available to satisfy the request comprises:
estimating an effect of adjusting operating of the flexible resource; and
comparing the effect to the threshold of the key performance indicators.

8. The system of claim 7, wherein the processor is further configured to:
cancel operation of the flexible resource based on a determination that the KPI threshold is exceed.

9. The system of claim 8, wherein the processor is further configured to:
transmit an indication to a requestor, the indication including a decline of the request.

10. The system of claim 1, wherein the flexible resource profile comprises a service level contract for the site.

11. A method for flexible resource management, the method comprising:
receiving a request to adjust power consumption for a site;
identifying a plurality of flexible resources for the site using auto discovery;
obtaining a flexible resource profile for each of the plurality of flexible resources;
analyzing the flexible resource profiles to identify at least one flexible resource from the plurality of flexible resources available to satisfy the request; and
operating the at least one flexible resource to satisfy the request.

12. The method of claim 11, wherein the at least one flexible resource comprises a heating ventilation and air conditioning (HVAC) system, an elevator, a power storage system, and a renewable energy system.

13. The method of claim 11, further comprising transmitting a confirmation to a requestor associated with the request.

14. The method of claim 13, wherein the confirmation comprises a power consumption change indicator.

15. The method of claim 11, wherein the request comprises a financial incentive for adjusting power consumption for the building.

16. The method of claim 11, wherein the flexible resource profile includes key performance indicators for the site, each key performance indicator (KPI) having a threshold.

17. The method of claim 16, wherein identifying the flexible resource available to satisfy the request comprises:
estimating an effect of adjusting operating of the flexible resource; and
comparing the effect to the threshold of the key performance indicators.

18. The method of claim 17, further comprising canceling operation of the flexible resource based on a determination that the KPI threshold is exceed.

19. The method of claim 18, further comprising transmitting an indication to a requestor, the indication including a decline of the request.

20. The method of claim 10, wherein the flexible resource profile comprises a service level contract for the building.
